(19) United States
(12) Patent Application Publication
(10) Pub. No.: US 2014/0355921 A1
(43) Pub. Date: Dec. 4, 2014

(54) BEARING FOR ROTATABLY MOUNTING A ROTATIONAL PART AND DENTAL HANDPIECE WITH CORRESPONDING BEARING

(71) Applicant: KALTENBACH & VOIGT GMBH, Biberach (DE)

(72) Inventors: Bernhard Kuhn, Biberach (DE); Julia Moll, Ehingen/Briel (DE); Thomas Roesch, Warthausen (DE); Juergen Butscher, Leutkirch (DE)

(73) Assignee: KALTENBACH & VOIGT GMBH, Biberach (DE)

(21) Appl. No.: 14/268,132

(22) Filed: May 2, 2014

(30) Foreign Application Priority Data
Jun. 3, 2013 (EP) 13 170 274.8

(51) Int. Cl. F16C 33/60; F16C 33/58

(52) U.S. Cl. CPC F16C 33/605; F16C 33/583
USPC 384/499

(57) ABSTRACT

A bearing for rotatably mounting a rotational part, for example a turbine rotor of a dental handpiece, has a plurality of roll bodies, in particular balls, arranged between an inner bearing ring and an outer bearing ring, a cage surrounding the roll bodies in an axial direction, and a locking element for axially locking the bearing rings with respect to each other, wherein the locking element has a ring-like or ring-segment-like securing element fitted on an inner circumference of the outer bearing ring or on an outer circumference of the inner bearing ring in a region of the cage such that the locking element blocks the roll bodies in the axial direction.

### CROSS-REFERENCE TO RELATED APPLICATION

The priority benefit of European patent application No. 13170274.8, entitled “Bearing For Rotatably Mounting a rotational Part and Dental Handpiece With Corresponding Bearing” filed on Jun. 3, 2013, is hereby claimed. The entire disclosure of the above application is incorporated herein by reference.

### BACKGROUND OF THE INVENTION

1. Field of the Invention

The invention relates to a bearing for rotatably mounting a rotational part, where the rotational part can be, for example, a turbine rotor of a dental handpiece. Furthermore, the present invention relates to a dental handpiece having such a bearing.

2. Related Technology

Dental treatments are mainly carried out with tools which work to remove the tooth substance. The classic treatment tool is a dental drill which is usually rotatably mounted in the head region of a dental handpiece and with the aid of which tooth substance is removed. In this case, the drill is arranged in a tool-holder which is located in the head region of the handpiece and is set rotating by means of a drive. Electric drives as well as turbines can be used for this.

Highly diverse embodiments of bearings with the aid of which, for example, the turbine rotors of dental turbine handpieces can be rotatably mounted are known from the prior art. A preferred bearing is known by the term “angular contact bearing.” It is distinguished by the fact that one of the two bearing rings constituting the running faces for the roll bodies of the bearing, that is, for example, for the balls, has a shoulder that is ground off on one side. This configuration makes it possible to build so-called solid cages in the bearing with the aid of which the balls are positioned in a certain way in relation to each other. Such solid cages result in the bearing having important advantages in terms of stability techniques.

On the other hand, however, the shoulder of one of the bearing rings that is ground off on one side results in the bearing only being loadable on one side in the axial direction. This disadvantage, in the case of an installed bearing, assuming that this has also been correctly built in, is insignificant in principle, since during operation as a rule a bearing need only compensate for forces coinciding with its main loading direction. Usually, it is therefore possible to proceed on the assumption that during operation there are no substantial forces in the axial direction. When handling the bearing, however, in particular when installing or removing it, it is very often found that a bearing or one of the bearing rings needs to be loaded in the axial direction and in particular also in the wrong direction and the bearing then breaks into its individual parts. If this is the case, the whole structural unit consisting of bearing and rotatably mounted element—that is, for example, the whole turbine rotor—is mostly unusable and needs to be completely replaced by a new unit.

To prevent this kind of break-up of such bearings that can be loaded on one side, it is known from the prior art that so-called centrifugal discs can be welded on the inner ring of the bearing that counter any disintegration of the bearing with a certain resistance. This welding-on of the centrifugal disc, however, represents a comparatively unreliable connection that can also only be reliably tested by means of destruction. A further disadvantage lies in the fact that incorrect positioning of this centrifugal disc can result in an imbalance which in the case of extremely high rotational speeds of a dental turbine can have a very negative influence upon the running behavior.

### SUMMARY OF THE INVENTION

The invention provides a novel solution for realizing a bearing which allows a cage to be used and nevertheless attain axial locking of the bearing rings with respect to one another.

Accordingly, the invention provides a bearing for rotatably mounting a rotational part, for example a turbine rotor of a dental handpiece, wherein the bearing has:

a plurality of roll bodies, preferably balls, arranged between an inner bearing ring and an outer bearing ring,

a cage surrounding the roll bodies in an axial direction, and

a locking element for axially locking the bearing rings with respect to each other, wherein the locking element has a ring-like or ring-segment-like securing element fitted on an inner circumference of the outer bearing ring or on an outer circumference of the inner bearing ring in a region of the cage such that the locking element blocks the roll bodies in the axial direction.

The solution in accordance with the invention is based on the idea of using, as a locking element for securing the two bearing rings with respect to one another, a ring-like securing element which is detachably fitted on one of the two bearing rings in the region of the cage in such a way that it blocks the roll bodies in the axial direction.

In accordance with the invention a bearing for rotatably mounting a rotational part, for example a turbine rotor of a dental handpiece, is therefore proposed, wherein the bearing has a plurality of roll bodies, preferably balls, arranged between an inner bearing ring and an outer bearing ring, a cage surrounding the roll bodies in the axial direction, and a locking element for axially locking the bearing rings with respect to each other, and wherein in accordance with the invention the locking element has a ring-like or ring-segment-like securing element which is fitted on the inner circumference of the outer bearing ring or on the outer circumference of the inner bearing ring in a region of the cage—preferably in a form-locking and/or force-locking manner—in such a way that the locking element blocks the roll bodies when loaded wrongly in the axial direction and prevents break-up.

In particular, the securing element can be formed by an elastic element—made from plastic material for example—having a cross section which is preferably substantially uniform over its whole periphery and is detachably connected to, in particular latched with, the corresponding bearing ring. After installation of the bearing, this securing element thus simply needs to be snapped into the corresponding bearing ring and then ensures the desired axial locking of the bearing rings with respect to each other in one direction.

For axial locking in the other direction, a further second securing element is preferably provided that is connected in one piece with one of the bearing rings. This second securing element can be in particular an end region extending from the corresponding bearing ring in the direction of the other bearing ring, with both securing elements in combination then guaranteeing complete locking of the bearing rings with respect to each other in the axial direction. Preferably, the two securing elements are each arranged on the outer bearing ring, since in this case they do not then need to rotate together with the rotational part and in particular cannot lead to a possible imbalance that could negatively impair the running behavior of the whole arrangement.

The bearing in accordance with the invention is in turn preferably configured in the form of the angular contact bearing already mentioned above. In other words, the bearing rings each have a depression which forms a running face for the roll bodies, wherein in the case of at least one of the two bearing rings a shoulder face located next to the depression is flattened or ground off. This embodiment renders possible simple installation of the bearing and in particular the use of the advantageous solid cages that have already been mentioned. The first securing element is then arranged in particular in the region of the flattened or ground-off shoulder of the corresponding bearing ring.

An advantage of the arrangement of the securing element in the region of the cage in accordance with the invention also lies, furthermore, in the fact that this additional securing element does not result in an extension of the whole bearing arrangement in the axial direction. Instead, an extremely compact bearing can be provided which as a result of the use of corresponding solid cages has extremely good running properties, yet nevertheless offers sufficient security in the axial direction so that disintegration need not be feared during installation or removal of the bearing. Such a bearing arrangement can be used in numerous fields of application and is not just limited to the field of dental or dental-medical handpieces.

### BRIEF DESCRIPTION OF THE DRAWINGS

The invention will be explained in greater detail in the following with reference to the enclosed drawing, in which:

FIG. 1 shows a dental turbine handpiece in which bearings in accordance with the invention are used;

FIG. 2 shows a sectional representation of a bearing configured in accordance with the invention;

FIG. 3 shows the front view of the bearing from FIG. 2; and

FIG. 4 shows an enlarged view of the end region of the bearing in which the detachably fitted securing element is arranged.

### DETAILED DESCRIPTION OF THE INVENTION

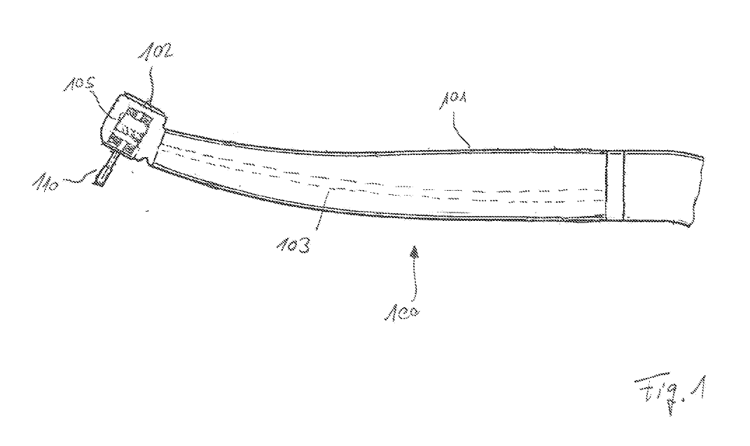

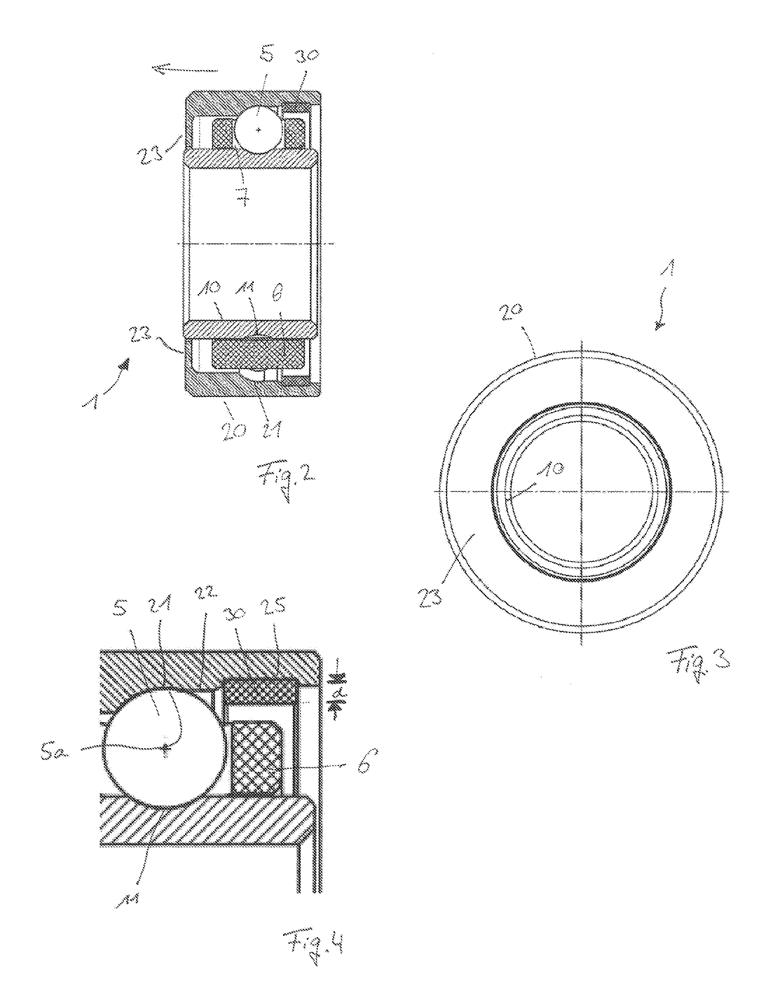

FIG. 1 shows, as a possible example of application of the present invention, a dental turbine handpiece 100 which has an elongate grip sleeve 101 with a head region 102 located at the front end. Provided at the head region 102 there is a drill 110 which is set rotating for treatment purposes by means of a turbine drive. For this, provided in the head region 102 there is a turbine rotor 105, shown diagrammatically, that is driven by way of a compressed-air line 103, extending through the grip sleeve 101, and is rotatably mounted by means of two bearings. The bearings are then formed in particular in accordance with the invention described below.

The bearing shown in section in FIG. 2 and generally provided with the reference numeral 1 is thus intended, for example, for mounting a turbine rotor of a dental turbine handpiece. The bearing 1 has, in the usual way, two bearing rings, an inner bearing ring 10 and also an outer bearing ring 20. Arranged in the ring-like interspace between both bearing rings 10, 20 there is a plurality of roll bodies, in the present case a plurality of balls 5, which can roll along running faces on the two bearing rings 10, 20 and as a result render possible rotation of the two bearing rings 10, 20 in relation to each other.

The balls 5 are held with the aid of a cage 6 so as to be uniformly distributed in the interspace between the two bearing rings 10, 20. The cage 6 is likewise constructed in a ring-like manner and has in each case corresponding recesses 7 to receive a respective ball 5. These recesses 7 are uniformly distributed over the whole circumference of the cage 6 so that it is ensured that the balls 5 can also run along the outer circumference of the inner ring 10 in a uniformly distributed manner, whereby the running smoothness of the bearing 1 is significantly increased. In the present case, this is a so-called solid cage which results in further improvement of the bearing 1 with regard to its stability.

To make it possible to fit the balls 5 in together with the solid cage 6, the bearing 1 is constructed as a so-called angular contact bearing. In the present case, this means that both bearing rings 10, 20, substantially in the central region, have circular-segment-type depressions 11 and 21 respectively which form the running faces for the balls 5 lying opposite each other. While, however, in the case of the inner bearing ring 10 the depression 11 is delimited on both sides by elevated regions of the inner ring 10, in the case of the outer bearing ring 20 the depression 21 is open towards the right-hand side. Here, the corresponding shoulder is flattened or ground off so that, viewed in this axial direction, the distance between the outer face of the inner bearing ring 10 and the inner face of the outer bearing ring 20—apart from a small elevation 22 directly delimiting the running face towards the right-hand side—is increased. While this results in installation of the bearing 1, that is, telescoping of the two bearing rings 10, 20 with the balls 5, arranged in between, and the cage 6, being facilitated or first being made possible, at the same time there is the risk that with higher loading of the outer bearing ring in the direction of the arrow (see FIG. 1), that is, to the left, the latter can be drawn off. In this case, the bearing 1 would disintegrate and be unusable.

In order to avoid this axial instability that is typical of angular contact bearings, in accordance with the present invention it is therefore proposed that a securing element in the form of a plastic ring 30 be arranged in the region of the flattened shoulder, that is, in the exemplary embodiment shown, to the right of the balls 5. This plastic ring 30, in the exemplary embodiment shown, is arranged on the inner face of the outer ring 20 in the ground-off or flattened region. It can be latched in particular with the outer bearing ring 20 or snapped into this ring, this being rendered possible by the fact that the outer bearing ring 20 has a corresponding circumferential depression 25. After the two bearing rings 10, 20 have been joined together with the balls 5 and the cage 6, the slightly flexible securing ring 30 is pushed in from the end face and pressed in the direction of the balls 5 for so long until it snaps into the circumferential recess 25. The configuration shown in FIG. 2, yet in particular in FIG. 4 on an enlarged scale, follows as a result.

It can be seen that the securing ring 30, viewed in the axial direction, is arranged in the region of the cage 6, i.e., towards the right-hand side has at most a very small projecting length. This arrangement results in the securing ring 30 claiming no additional space in the axial direction and accordingly not resulting in an extension of the construction of the bearing.

As can further be seen in FIG. 4, the securing ring 30 has, over its circumference, a uniform cross section with a thickness d which is dimensioned in such a way that in the axial direction it engages behind the balls 5 or, viewed radially, is at a shorter distance from the central axis of the bearing with its inner face 31 than the outer circumference 5a of the balls 5 remote from the central axis. In the case where in turn loading of the outer bearing ring 20 occurs in the direction of the arrow, the securing ring 30 would thus now collide with the balls 5 so that the outer bearing ring 20 cannot be pressed further in this direction. At the same time, the securing ring 30 does not overlap the cage 6 in the axial direction or, viewed in the radial direction, it is arranged completely outside the cage 6 so that in the case of the loading of the outer bearing ring 20 described above it is actually the balls 5, not, however, the cage 6, that collide with the securing ring 30. Both bearing rings 10, 20 are thus locked with respect to each other, viewed in both axial directions, and the problem described at the beginning of the risk that the bearing 1 can be damaged relatively easily is avoided as a result. In this connection, the securing ring 30 need not necessarily have a uniform cross section, but could also be configured in a variable manner, for example could have cams or interruptions or recesses. The use of a ring-segment-like securing element would also be possible as long as the securing function described above is guaranteed.

A second securing or locking element is formed, furthermore, at the end of the outer bearing ring 20 lying opposite the securing ring 30. Here the end region 23 is constructed in an angular manner and is drawn inwards in such a way that here there is only a minimum distance to the outer face of the inner bearing ring 10. This end region which is drawn inwards does not therefore contact the inner bearing ring 10, in order to avoid grinding. At the same time, however, it prevents the outer bearing ring 20 from being drawn off towards the right so that ultimately an extremely stable arrangement in the axial direction is obtained.

A further advantage of the two securing elements, that is, of the securing ring 30 and also of the end region 23 that is drawn inwards, lies in the fact that viewed from the two end faces of the bearing 10 only small free spaces or gaps remain so that without further sealing measures optimized lubricating properties of the bearing 1 are obtained. On the one hand, the penetration of dirt is prevented and, on the other hand, there is also no risk that lubricant will reach the outside so that all in all the bearing 1 is very low-maintenance.

Viewed all in all, a bearing is thus provided that is distinguished by extremely good running properties, yet at the same time also has sufficient stability in particular in the axial direction, rendering possible simple installation and removal of the bearing. In addition, on account of the fact that the securing ring does not overlap the cage in the axial direction the securing measures do not lead to an axial extension of the whole arrangement so that extremely compact bearings can still be realized. These can then not only be used for rotatable mounting of elements that are part of dental handpieces or hand instruments, but can also be employed in manifold ways in a whole variety of fields of application.

1. A bearing for rotatably mounting a rotational part, wherein the bearing has:
a plurality of roll bodies arranged between an inner bearing ring and an outer bearing ring,
a cage surrounding the roll bodies in an axial direction, and
a locking element for axially locking the bearing rings with respect to each other, wherein the locking element has a ring-like or ring-segment-like securing element fitted on an inner circumference of the outer bearing ring or on an outer circumference of the inner bearing ring in a region of the cage such that the locking element blocks the roll bodies in the axial direction.

2. A bearing according to claim 1, wherein the securing element is fastened to a corresponding bearing ring in a form-locking and/or force-locking manner.

3. A bearing according to claim 1, wherein the securing element is formed by an elastic element that can be latched with the corresponding bearing ring.

4. A bearing according to claim 1, wherein the securing element has a cross section that is substantially identical over a periphery of the securing element.

5. A bearing according to claim 1, wherein the securing element does not overlap the cage in the axial direction of the bearing.

6. A bearing according to claim 1, wherein each bearing ring has a depression which forms a running face for the roll bodies, wherein in the case of at least one of the two bearing rings a shoulder face located next to the depression is flattened or ground off.

7. A bearing according to claim 6, wherein the securing element is arranged in a region of the flattened or ground-off shoulder of a corresponding bearing ring.

8. A bearing according to claim 1, wherein arranged on a side lying opposite the first securing element there is a second securing element connected in one piece with one of the bearing rings.

9. A bearing according to claim 8, wherein the second securing element is an angular end region extending from a corresponding bearing ring in a direction of the other bearing ring.

10. A bearing according to claim 8, wherein both the first securing element and the second securing element are arranged on the outer bearing ring.

11. A bearing according to claim 1, wherein the cage is a full cage or a solid cage.

12. A dental or dental-medical handpiece with a rotatably mounted element, wherein the handpiece has one or more bearings according to claim 1 for rotatably mounting the element.

13. A handpiece according to claim 12, comprising a dental turbine handpiece, and the rotatably mounted element is formed by a turbine rotor.

14. A bearing according to claim 1, wherein the roll bodies are balls.

15. A bearing according to claim 3, wherein the securing element is formed by a plastic element.
